(19) United States
(12) Patent Application Publication
(10) Pub. No.: US 2026/0360770 A1
(43) Pub. Date: Nov. 12, 2026

(54) SOLID OXIDE FUEL CELL INCLUDING ALLOY-PLATED INTERCONNECT AND METHOD FOR MANUFACTURING SAME

(71) Applicant: DONG-A UNIVERSITY RESEARCH FOUNDATION FOR INDUSTRY-ACADEMY COOPERATION, Busan (KR)

(72) Inventors: Jung Han KIM, Changwon-si (KR); Ki Young LEE, Ulsan (KR); Han Kyun SHIN, Changwon-si (KR)

(21) Appl. No.: 19/658,310

(22) Filed: Apr. 24, 2026

(30) Foreign Application Priority Data
May 8, 2025 (KR) 10-2025-0059438

(51) Int. Cl. H01M 8/0208; C25D 3/56; C25D 5/36; H01M 8/0228; H01M 8/10; H01M 8/241; H01M 8/12

(52) U.S. Cl. CPC H01M 8/0208; C25D 3/562; C25D 5/36; H01M 8/0228; H01M 8/10; H01M 8/241; H01M 2008/1293

(57) ABSTRACT

Proposed are a solid oxide fuel cell including an alloy-plated interconnect and a method for manufacturing the same. More specifically, the solid oxide fuel cell includes a plurality of unit cells, each having a fuel electrode, an air electrode, and a solid oxide electrolyte interposed therebetween, an interconnect electrically connecting the plurality of unit cells to each other, and a Co-Ni alloy thin film formed on a surface of the interconnect, the Co-Ni alloy thin film containing 50% to 84% Co, exhibiting a mixed phase of FCC and HCP structures, and having an equiaxed grain structure at the nanometer scale.

### CROSS REFERENCE TO RELATED APPLICATION

The present application claims priority to Korean Patent Application No. 10-2025-0059438, filed May 08, 2025, the entire contents of which is incorporated herein for all purposes by this reference.

### BACKGROUND OF THE INVENTION

### Field of the Invention

The present disclosure relates to a solid oxide fuel cell (SOFC) including an alloy-plated interconnect for suppressing chromium volatilization, and a method for manufacturing the same.

This work was supported by the Ministry of Trade, Industry and Energy (MOTIE) and the Korea Evaluation Institute of Industrial Technology (KEIT) in 2024 (Development of 48 V transparent heating safety glass materials and components based on metal thin-film coating, RS-2024-00507673).

### Description of the Related Art

Solid oxide fuel cells (SOFCs) generally exhibit high power generation efficiency and have been widely considered for diverse applications, including vehicles, ships, residences, commercial buildings, and industrial power generation. Structurally, SOFCs consist of a plurality of unit cells electrically connected via interconnects made of metallic materials.

SOFCs typically operate at elevated temperatures in the range of 600°C to 900°C. At such operating temperatures, hydrogen molecules supplied to a fuel electrode (anode) undergo electrochemical oxidation, producing hydrogen atoms and electrons. The electrons generated at the anode flow through an external circuit, generating power for the fuel cell, and subsequently return to an air electrode (cathode). This process is continuously repeated during operation.

This constitutes the fundamental operating mechanism of SOFCs. In this process, the interconnect electrically connects adjacent cells, enabling electron transport from the anode of one cell to the cathode of the next via the external circuit. It also serves as a gastight barrier that separates the fuel and the air, thereby preventing direct mixing.

However, the high operating temperature of SOFCs inevitably introduces critical challenges such as high-temperature degradation and thermal failure. These issues are closely associated with oxide protective scales formed on the surface of the interconnect.

Fe-Cr-based stainless steels, commonly employed as interconnect materials in SOFCs, exhibit excellent corrosion resistance due to the formation of oxide protective scales, such as Cr₂O₃, on their surface. At ambient conditions, the thickness of this scale is typically on the order of approximately 3 nm. However, upon exposure to high-temperature environments, the scale grows significantly thicker. The thickened scale can release volatile chromium species at high-temperatures. The released chromium species can migrate toward the air electrode, where they react with oxygen and contaminate the air electrode. The release of the volatile chromium species from the oxide protective scale on the interconnect surface is generally referred to as chromium volatilization, while the subsequent contamination of the air electrode due to reaction of these chromium species with oxygen is commonly referred to as chromium poisoning (Cr poisoning).

In summary, metallic interconnects in SOFCs are typically composed of Fe-Cr alloys, and chromium species formed at high temperatures can volatilize and redeposit on the air electrode surface, leading to performance degradation of the air electrode. Such chromium poisoning is recognized as a primary cause of high-temperature degradation and thermal failure in SOFC systems.

Accordingly, there is an urgent need for the development of SOFC technologies incorporating interconnects capable of effectively suppressing chromium volatilization.

The foregoing is intended merely to aid in the understanding of the background of the present disclosure, and is not intended to mean that the present disclosure falls within the purview of the related art that is already known to those skilled in the art.

### Documents of Related Art

(Patent document 1) Korean Patent No. 10-2491289 (published on January 25, 2023)

(Patent document 2) Korean Patent Application Publication No. 10-2022-0106080 (published on July 28, 2022)

### SUMMARY OF THE INVENTION

Accordingly, the present disclosure has been made keeping in mind the above problems occurring in the related art, and one objective of the present disclosure is to provide a solid oxide fuel cell including an alloy-plated interconnect formed by an electroplating process, and a method for manufacturing the same.

The objectives of the present disclosure are not limited to those mentioned above, and other objectives not mentioned will be clearly understood from the following description.

In order to achieve the above objective, according to one aspect of the present disclosure, there is provided a solid oxide fuel cell including an alloy-plated interconnect, the solid oxide fuel cell including: a plurality of unit cells, each having a fuel electrode, an air electrode, and a solid oxide electrolyte interposed therebetween; and an interconnect configured to electrically connect the plurality of unit cells to each other. A Co-Ni alloy thin film containing 50% to 84% Co may be formed on a surface of the interconnect. The Co-Ni alloy thin film may exhibit a mixed phase of FCC and HCP structures. The Co-Ni alloy thin film may have an equiaxed grain structure at the nanometer scale.

According to another aspect of the present disclosure, there is provided a method for manufacturing a solid oxide fuel cell including an alloy-plated interconnect, the method being for preparing the interconnect that is applicable to manufacture of a solid oxide fuel cell including a plurality of unit cells, each having a fuel electrode, an air electrode, and a solid oxide electrolyte disposed therebetween, and an interconnect electrically connecting the unit cells to each other, and the method including: preparing an interconnect; plating a Co strike; and electroplating a Co-Ni alloy thin film.

The solid oxide fuel cell including the alloy-plated interconnect and the method for manufacturing the same according to the present disclosure can provide the following advantageous effects.

First, by forming an alloy thin film on the surface of the interconnect via electroplating, chromium volatilization can be effectively suppressed, while mechanical properties can be enhanced through nanometer-scale grains and solid solution strengthening arising from the coexistence of FCC and HCP phases.

Additionally, by applying an alloy coating to the interconnect surface via electroplating, it is possible to achieve a simple and cost-effective process while producing a high-quality thin film.

Furthermore, Co-Ni alloy plating forms a coating layer exhibiting high oxidation stability, which can effectively block chromium diffusion and oxidation pathways, thereby suppressing chromium volatilization. This contributes to improved oxidation resistance and extended lifetime of the interconnect under high-temperature operating conditions.

The effects of the present disclosure are not limited to those mentioned above, and other effects not mentioned will be clearly understood from the following description.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 illustrates the X-ray diffraction (XRD) patterns of a Co-Ni alloy according to an embodiment of the present disclosure;

FIGS. 2A and 2B illustrate the crystal structure of a Co-Ni alloy thin film according to an embodiment of the present disclosure;

FIG. 3 illustrates the microhardness of a Co-Ni alloy thin film as a function of Co content according to an embodiment of the present disclosure;

FIG. 4 is a flowchart illustrating an interconnect preparation step in a method for manufacturing a solid oxide fuel cell including an alloy-plated interconnect according to an embodiment of the present disclosure;

FIG. 5 illustrates XRD measurement results of Example 1, Comparative Example 1, and Comparative Example 2 according to an embodiment of the present disclosure;

FIGS. 6A and 6B illustrate scanning electron microscopy (SEM) imaging and energy dispersive spectroscopy (EDS) line scan results of Example 1, Comparative Example 1, and Comparative Example 2 according to an embodiment of the present disclosure;

FIG. 7 illustrates tensile test results of Example 1-1, Comparative Example 1-1, and Comparative Example 2-1 according to an embodiment of the present disclosure;

FIG. 8 illustrates micro-Vickers hardness test results of Example 1 and Comparative Example 2 according to an embodiment of the present disclosure;

FIG. 9 illustrates area-specific resistance (ASR) evaluation results of Example 1, Comparative Example 1, and Comparative Example 2 according to an embodiment of the present disclosure;

FIG. 10 illustrates inductively coupled plasma–optical emission spectroscopy (ICP-OES) analysis results of Example 1 and Comparative Example 2 according to an embodiment of the present disclosure; and

FIG. 11 illustrates focused ion-beam (FIB) channeling imaging of Example 1, Comparative Example 1, and Comparative Example 2 according to an embodiment of the present disclosure.

### DETAILED DESCRIPTION OF THE INVENTION

The advantages and features of the present disclosure and the ways of accomplishing them will become apparent from the following detailed description of exemplary embodiments in conjunction with the accompanying drawings. The present disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art. Meanwhile, terms used in this specification are selected to describe embodiments and thus should not be construed as the limit of the present disclosure. As used herein, the singular forms are intended to include the plural forms as well, unless the context clearly indicates otherwise.

The present disclosure relates to a solid oxide fuel cell including an alloy-plated interconnect and a method for manufacturing the same, in which a Co-Ni alloy is plated on a surface of an interconnect so as to effectively suppress chromium volatilization toward a cathode under high-temperature conditions.

Hereinafter, a solid oxide fuel cell including an alloy-plated interconnect and a method for manufacturing the same according to preferred embodiments of the present disclosure will be described in detail with reference to the accompanying drawings.

A solid oxide fuel cell including an alloy-plated interconnect according to one embodiment of the present disclosure may include: a plurality of unit cells, each having a fuel electrode, an air electrode, and a solid oxide electrolyte interposed therebetween; an interconnect configured to electrically connect the plurality of unit cells to each other; and a Co-Ni alloy thin film formed on a surface of the interconnect.

Here, except for the interconnect, which is a characteristic configuration of the present disclosure, the plurality of unit cells each including the fuel electrode, the air electrode, and the solid oxide electrolyte may be configured in the same manner as corresponding components of a conventional solid oxide fuel cell. Accordingly, a detailed description thereof will be omitted.

The interconnect may be formed of a material having excellent heat resistance, such as Fe-Cr-based stainless steel, nickel, or the like, so as to be operable at the operating temperature of solid oxide fuel cells (SOFCs).

The Co-Ni alloy thin film is formed on the surface of the interconnect via a plating process. Through Co-Ni alloy plating, a coating layer exhibiting high oxidation stability is formed, which may effectively block chromium diffusion and oxidation pathways, thereby suppressing chromium volatilization. This contributes to improved oxidation resistance and extended lifetime of the interconnect under high-temperature operating conditions.

More specifically, chromium atoms tend to diffuse along the metal surface at elevated temperatures, eventually reaching the surface where they can volatilize. The Co-Ni alloy coating layer serves as a diffusion barrier that physically suppresses the migration of chromium atoms by interrupting their diffusion pathways. Additionally, under high-temperature oxidizing environments, chromium readily forms Cr₂O₃, but such oxide protective scales are prone to volatilization. In this case, the Co-Ni alloy coating layer not only prevents direct contact between chromium and oxygen but also promotes the formation of more thermodynamically stable oxide layers, such as oxides with spinel structure (e.g., Co₂O₃ and NiCo₂O₄). These spinel oxides act as protective layers that suppress or delay the formation and volatilization of chromium oxides.

Both cobalt and nickel exhibit superior oxidation resistance at high temperatures. Upon oxidation, they preferentially form dense spinel-structured oxide layers, which act as a protective barrier. These oxides are formed prior to chromium oxidation, thereby inhibiting the exposure of chromium to the external oxidizing environment. Furthermore, Co and Ni form an isomorphous alloy system as they are completely miscible in both the solid and liquid states. The mixed-phase structure of the Co-Ni alloy effectively hinders chromium diffusion, particularly along grain boundaries and through lattice sites. Consequently, the transport of chromium atoms toward the surface and their subsequent volatilization may be significantly suppressed.

A Co-Ni alloy thin film containing 50% to 84% Co may be formed on the surface of the interconnect. The Co-Ni alloy exhibits phase-dependent structural characteristics depending on the Co content and is capable of forming both face-centered cubic (FCC) and hexagonal close-packed (HCP) phases.

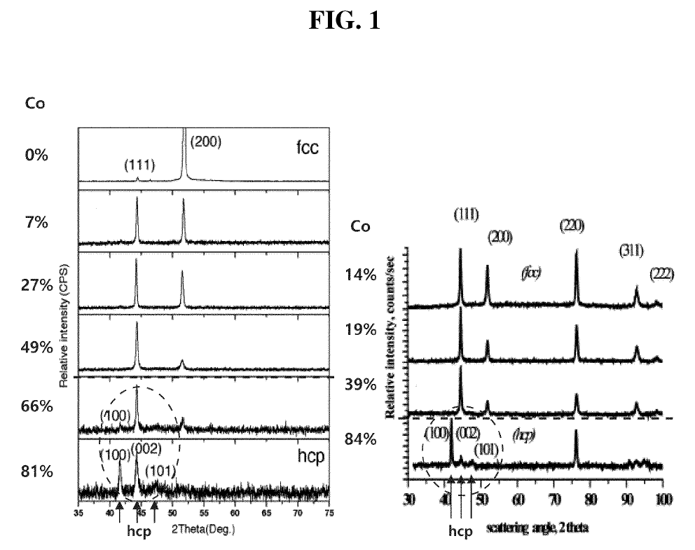

As confirmed from the X-ray diffraction (XRD) patterns shown in FIG. 1, a mixed phase consisting of FCC and HCP structures is observed when the Co content ranges from 66% to 84%. On the contrary, when the Co content is equal or less than 49%, a single FCC phase is predominantly formed. Accordingly, it can be inferred that the Co-Ni alloy exhibits a mixed-phase structure within a Co content range of 50% to 84%.

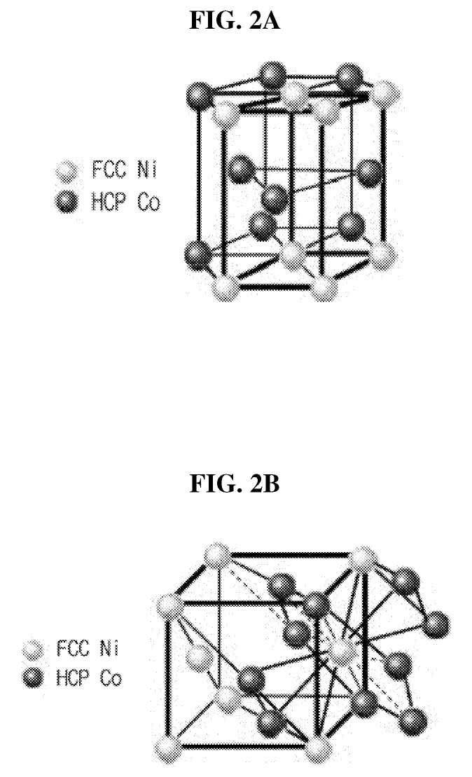

FIGS. 2A and 2B illustrate the crystal structure of the Co-Ni alloy thin film. FIG. 2A shows the crystal structure of an FCC-phase Ni embedded within an HCP-phase Co matrix, whereas FIG. 2B shows the crystal structure of an HCP-phase Co embedded within an FCC-phase Ni matrix. These crystal structures exist in the form of substitutional solid solutions, which significantly contribute to enhanced mechanical strength through a solid solution strengthening mechanism.

The Co-Ni alloy thin film according to the present disclosure, containing 50% to 84% Co, exhibits a mixed phase of FCC and HCP structures and has an equiaxed grain structure at the nanometer scale.

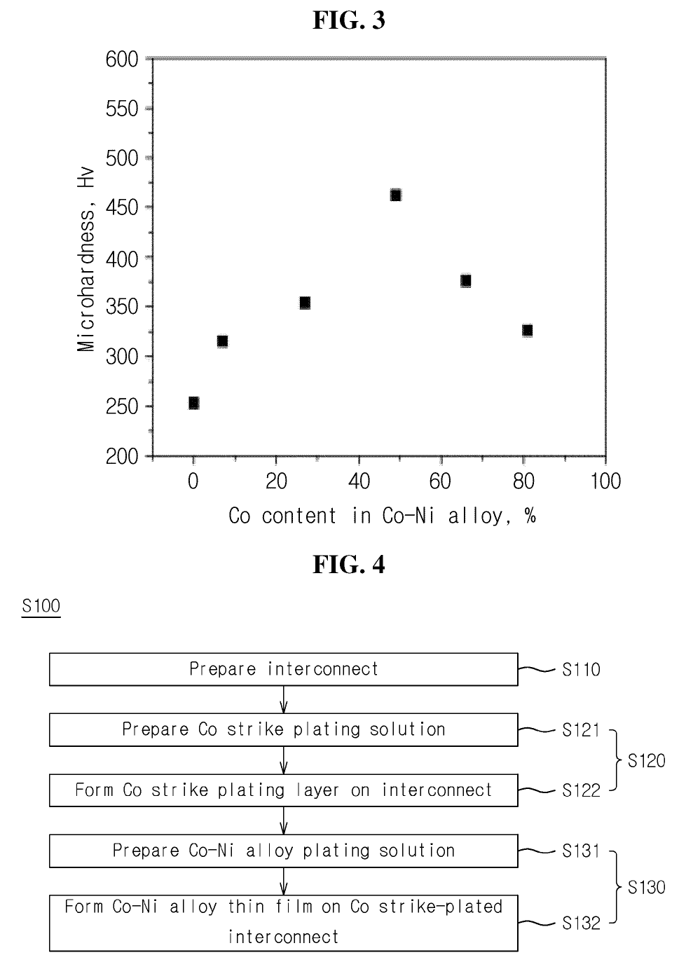

FIG. 3 illustrates the microhardness of the Co-Ni alloy thin film as a function of Co content. As shown in FIG. 3, the highest microhardness is observed at a peak corresponding to a Co content in the range of 40% to 60%. Additionally, the Co-Ni alloy thin film exhibits higher microhardness than that of pure Ni when the Co content is 5% to 81%.

In the present disclosure, based on the results shown in FIGS. 1 and 3, a Co-Ni alloy containing 50% to 84% Co is plated on the surface of the interconnect in order to achieve improved mechanical properties of the interconnect surface through the solid solution strengthening effect of the mixed-phase structure.

The solid oxide fuel cell including the alloy-plated interconnect according to the embodiment of the present disclosure may further include a Co strike plating layer.

The Co strike plating layer may be formed between the interconnect and the Co-Ni alloy thin film, and may be provided on the surface of the interconnect prior to electroplating of the Co-Ni alloy in order to obtain the effects of improved adhesion and surface activation.

A method for manufacturing a solid oxide fuel cell including an alloy-plated interconnect according to another embodiment of the present disclosure may include: preparing a plurality of unit cells, each having a fuel electrode, an air electrode, and a solid oxide electrolyte interposed therebetween; and manufacturing an interconnect for electrically connecting the plurality of unit cells to each other.

Here, except for the step of manufacturing the interconnect, which is a characteristic step of the present disclosure, the step of preparing the plurality of unit cells, each having the fuel electrode, the air electrode, and the solid oxide electrolyte, may be carried out in the same manner as corresponding steps in a conventional method for manufacturing a solid oxide fuel cell. Accordingly, a detailed description thereof will be omitted.

As illustrated in FIG. 4, the step of manufacturing the interconnect (S100) of the present disclosure may include preparing an interconnect (S110), plating a Co strike (S120), and electroplating a Co-Ni alloy thin film (S130).

In the step of preparing the interconnect (S110), a material having excellent heat resistance, such as Fe-Cr-based stainless steel, nickel, or the like, may be prepared so as to be suitable for use at the operating temperature of solid oxide fuel cells (SOFCs).

The step of plating the Co strike (S120) may include preparing a Co strike plating solution (S121) and forming a Co strike plating layer on the interconnect (S122).

In the step of preparing the Co strike plating solution (S121), a Co strike plating solution containing 100 g/L of CoCl₂·6H₂O and 100 mL/L of HCl may be prepared.

The step of forming the Co strike plating layer on the interconnect (S122) may include performing strike plating on the interconnect, which serves as an cathode, using a Pt mesh as a anode. In this case, the strike plating may be carried out under conditions of a flow rate of 200 rpm, a current density of 300 mA/cm², and a plating duration of 50 seconds. All the strike plating in the present disclosure are performed under the above-described conditions.

The step of electroplating the Co-Ni alloy (S130) may include preparing a Co-Ni alloy plating solution (S131) and a forming a Co-Ni alloy thin film (S132).

In the step of preparing the Co-Ni alloy plating solution (S131), a Co-Ni alloy plating solution containing 40 to 70 g/L of CoCl₂·6H₂O may be prepared.

In the step of forming the Co-Ni alloy thin film (S132), the strike-plated interconnect may be immersed in the Co-Ni alloy plating solution prepared in step (S131) to form a Co-Ni alloy thin film on the surface of the interconnect.

The Co-Ni alloy thin film may contain 50% to 84% Co, and may exhibit a mixed phase of FCC and HCP structures.

Additionally, the Co-Ni alloy thin film may have an equiaxed grain structure at the nanometer scale.

Here, the electroplating process for forming the Co-Ni alloy thin film on the surface of the interconnect is employed because, compared to other deposition techniques such as sputtering, sol-gel, or electrophoretic deposition, electroplating offers advantages in terms of process simplicity, cost-effectiveness, and the ability to produce high-quality thin films.

Hereinafter, the present disclosure will be described in more detail with reference to specific Examples, Comparative Examples, and Experimental Examples. The following Examples, Comparative Examples, and Experimental Examples are provided merely for illustrative purposes to facilitate understanding of the present disclosure, and the scope of the present disclosure is not limited thereto.

### Example 1

Preparation of 60Co-40Ni alloy-plated interconnect

An interconnect plated with a 60Co-40Ni alloy was prepared using SUS430, which is an Fe-Cr-based stainless steel. Electroplating was performed on the strike-plated interconnect using an alloy plating solution containing 100 to 300 g/L of NiSO₄·6H₂O, 10 to 100 g/L of NiCl₂·6H₂O, 1 to 100 g/L of CoSO₄·7H₂O, 40 to 70 g/L of CoCl₂·6H₂O, 1 to 50 g/L of H₃BO₃, 1 to 50 g/L of C₆H₈O₆, and 1 to 50 g/L of C₇H₅NO₃SNa·2H₂O. Ni was used a cathode, and the electroplating was carried out under the following conditions: a temperature of 50°C, a flow rate of 200 rpm, and a current density of 30 mA/cm². Through the above-described method, a 60Co-40Ni alloy-plated interconnect was obtained.

### Example 1-1

Preparation of 60Co-40Ni alloy thin film

In order to perform a tensile test on an alloy thin film, alloy plating was carried out, followed by separation of the deposited thin film. Unlike Example 1, electroplating was performed on a Ti plate, and the process was conducted with a pump voltage set to 160 V. Through the above-described method, a 60Co-40Ni alloy thin film was obtained.

### Comparative Example 1

Preparation of 40Co-60Ni alloy-plated interconnect

An interconnect plated with a 40Co-60Ni alloy was prepared using SUS430, which is an Fe-Cr-based stainless steel. Electroplating was performed on the strike-plated interconnect using an alloy plating solution containing 100 to 300 g/L of NiSO₄·6H₂O, 10 to 100 g/L of NiCl₂·6H₂O, 1 to 100 g/L of CoSO₄·7H₂O, 5 to 10 g/L of CoCl₂·6H₂O, 1 to 50 g/L of H₃BO₃, 1 to 50 g/L of C₆H₈O₆, and 1 to 50 g/L of C₇H₅NO₃SNa·2H₂O. Ni was used a cathode, and the electroplating was carried out under the following conditions: a temperature of 50°C, a flow rate of 200 rpm, and a current density of 30 mA/cm². Through the above-described method, a 40Co-60Ni alloy-plated interconnect was obtained.

### Comparative Example 1-1

Preparation of 40Co-60Ni alloy thin film

In order to perform a tensile test on an alloy thin film, electroplating was carried out, followed by separation of the deposited thin film. Unlike Comparative Example 1, electroplating was performed on a Ti plate, and the process was conducted with a pump voltage set to 160 V. Through the above-described method, a 40Co-60Ni alloy thin film was obtained.

### Comparative Example 2

Preparation of pure Co-plated interconnect

An interconnect plated with pure Co was prepared using SUS430, which is an Fe-Cr-based stainless steel. Electroplating was performed on the strike-plated interconnect using a plating solution containing 100 g/L of CoCl₂·6H₂O and 35 g/L of H₃BO₃. A Pt mesh was used as a cathode, and the electroplating was carried out under the following conditions: a temperature of 25°C, a flow rate of 200 rpm, and a current density of 30 mA/cm². Through the above-described method, a pure Co-plated interconnect was obtained.

### Comparative Example 2-1

Preparation of 100Co alloy thin film

In order to perform a tensile test on a pure Co thin film, electroplating was carried out, followed by separation of the deposited thin film. Unlike Comparative Example 2, electroplating was performed on a Ti plate, and the process was conducted with a pump voltage set to 160 V. Through the above-described method, a pure Co thin film was obtained.

### XRD Analysis and Chromium Volatilization Evaluation (SEM and EDS Line Scan) of Co-Ni Alloy-Plated Interconnects

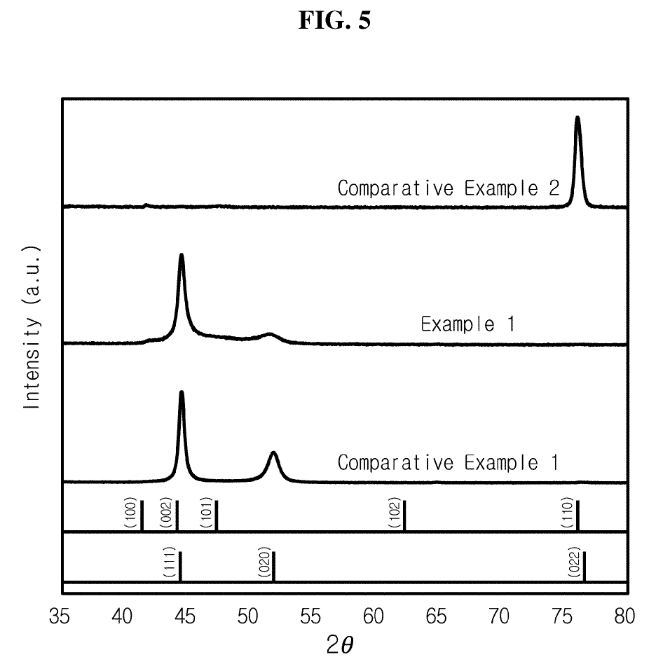

The X-ray diffraction (XRD) results of Example 1, Comparative Example 1, and Comparative Example 2, corresponding to the interconnects plated with Co-Ni alloy thin films of different Co contents or a pure Co thin film, are presented in FIG. 5. Here, the thickness of the plated thin films was in the range of 5 to 8 μm.

Referring to FIG. 5, in the case of Comparative Example 2, in which the interconnect was plated with a pure Co thin film, the (110)HCP peak was observed as the dominant phase. On the contrary, for the Co-Ni alloy thin films of Example 1 and Comparative Example 1, characteristic peaks corresponding to (002)HCP, (111)FCC, and (020)FCC were predominantly observed, indicating the coexistence of FCC and HCP phases in the Co-Ni alloy system. Furthermore, the intensity of the (020)FCC peak decreased in Example 1 compared to Comparative Example 1. This suggests that the fraction of the FCC phase decreases with increasing Co content.

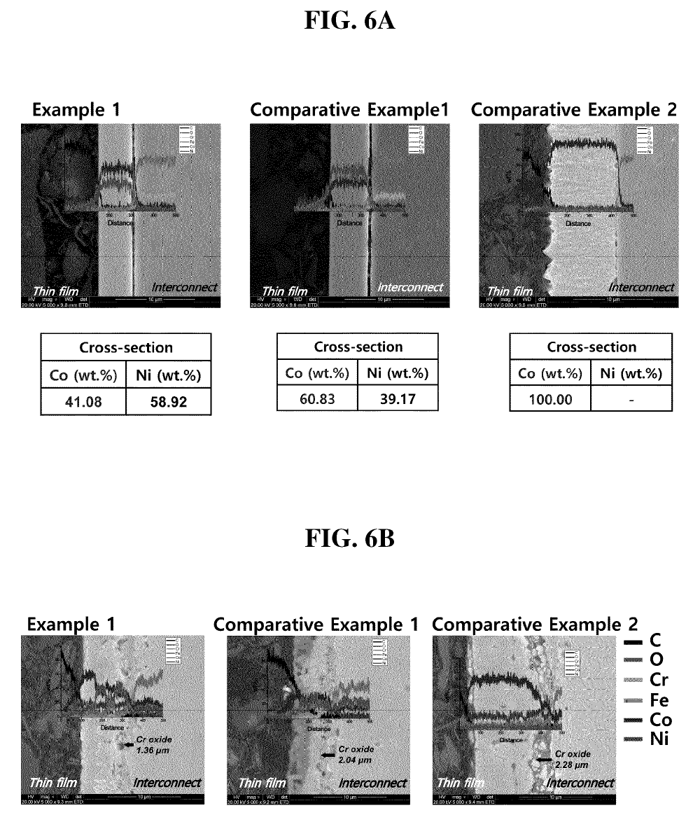

To analyze the compositional distribution of alloy elements, EDS line scan analysis was conducted on the cross-sections of Example 1, Comparative Example 1, and Comparative Example 2, corresponding to the interconnects plated with Co-Ni alloy thin films of different Co contents or a pure Co thin film. Here, the thickness of the plated thin films was in the range of 5 to 8 μm. The results are presented in FIG. 6A.

Referring to FIG. 6a, the EDS line scan results show that Example 1 consisted of 60.83 wt% Co and 39.17 wt% Ni, Comparative Example 1 consisted of 41.08 wt% Co and 58.92 wt% Ni, and Comparative Example 2 consisted of 100 wt% Co. These confirm that the deposited films are in good agreement with the target compositions of 60Co-40Ni, 40Co-60Ni, and 100Co, respectively.

To evaluate chromium volatilization behavior after thermal exposure, each sample was subjected to heat treatment at 800°C for 100 hours. Subsequently, scanning electron microscopy (SEM) imaging and energy dispersive spectroscopy (EDS) line scan analyses were conducted on the cross-sections of the samples to measure the thickness of the chromium oxide layer (i.e., chromium-enriched layer). The results are presented in FIG. 6B, where the EDS line scan analysis allows verification of whether outward diffusion of chromium oxide has occurred. Here, the thickness of the plated thin films was also in the range of 5 to 8 μm.

Referring to FIG. 6b, a chromium peak was observed at the interface between the interconnect and the plated thin film in all samples (Example 1, Comparative Example 1, and Comparative Example 2). This indicates that outward diffusion of chromium was effectively inhibited. These results provide strong evidence that plating a thin film on the interconnect plays a critical role in mitigating chromium volatilization under high-temperature conditions.

Moreover, as indicated by the thickness of the chromium oxide layer in each image, it is observed that the oxide layer thickness progressively decreased from Comparative Example 2 (pure Co thin film) to Comparative Example 1 and further to Example 1, i.e., with increasing Co content in the Co-Ni alloy thin film. Specifically, the chromium oxide thicknesses were measured to be 1.36 μm for Example 1, 2.04 μm for Comparative Example 1, and 2.28 μm for Comparative Example 2.

Notably, in Example 1, in which the interconnect was plated with a 60Co-40Ni alloy thin film, the chromium oxide thickness was reduced to approximately 55% of that in Comparative Example 2. This behavior can be attributed to the fact that chromium diffusion is relatively facile within the interconnect, whereas diffusion within spinel oxide layers such as Cr₂O₃ is significantly hindered. As a result, chromium tends to accumulate at the interfacial region between the interconnect and the alloy thin film, forming a localized chromium-enriched layer.

From the above results, it is concluded that the present disclosure provides a method for electroplating a Co-Ni alloy thin film having a controlled composition and a mixed FCC/HCP phase on the surface of an interconnect. At the same time, it is confirmed that the application of the Co-Ni alloy thin film effectively suppresses chromium volatilization and significantly reduces the thickness of the chromium oxide layer.

### Mechanical Property Evaluation of Co-Ni Alloy-Plated Interconnects (Tensile Test and Micro-Vickers Hardness Test)

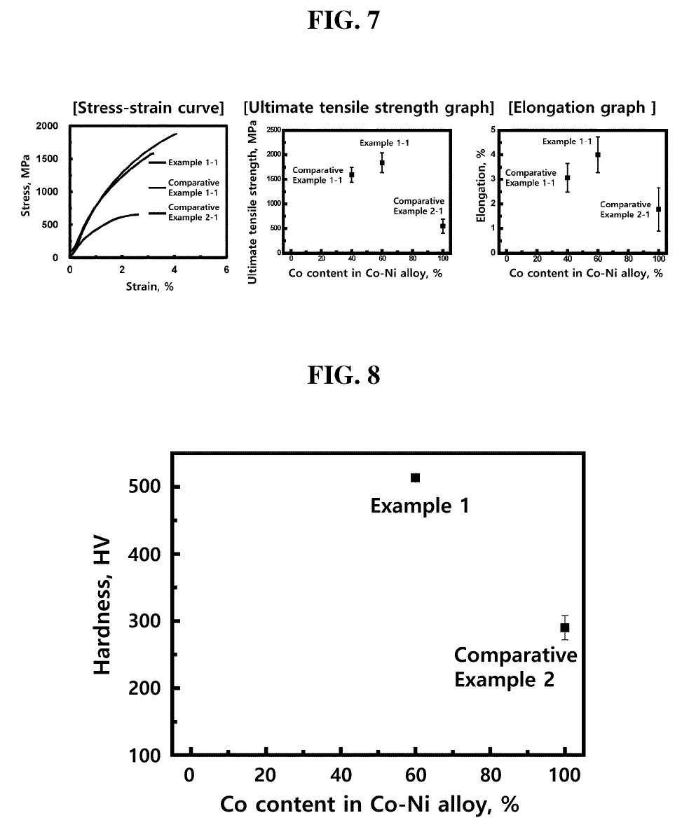

To evaluate the mechanical properties of the electroplated thin films, Example 1-1, Comparative Example 1-1, and Comparative Example 2-1 were prepared. Here, the thickness of the thin films was 10 μm. A tensile test was conducted on specimens with dimensions of 100 × 12.5 mm, and the results are presented in FIG. 7.

FIG. 7 illustrates the stress-strain curves, as well as the graphs of ultimate tensile strength and elongation. From the stress-strain curves, it is evident that Example 1-1 (60Co-40Ni alloy thin film) exhibited the highest stress and strain among all samples. Additionally, compared to Comparative Example 2-1 (pure Co thin film), Example 1-1 and Comparative Example 1-1 (alloy thin films) showed significantly higher stress and strain values.

Furthermore, the graphs of ultimate tensile strength and elongation clearly show the dependence of mechanical properties on Co content. For Example 1-1 and Comparative Example 1-1 (alloy thin films), the ultimate tensile strength exceeded 1500 MPa and the elongation exceeded 3%. On the contrary, Comparative Example 2-1 (pure Co thin film) exhibited an ultimate tensile strength of approximately 500 MPa and an elongation of approximately 1.75%.

To further evaluate the mechanical properties of the electroplated thin films, micro-Vickers hardness tests were conducted on Example 1 and Comparative Example 2. The plating thickness was set to 150 μm. This thickness was determined based on standard testing requirements (ASTM E384 and ISO 6507), which indicate that a minimum sample thickness of approximately 80 μm is required for reliable microhardness measurements (based on an indentation diagonal length of ~50 μm). To ensure stable and reliable measurements, the thickness was increased to 150 μm.

To minimize measurement errors caused by surface roughness after plating, surface grinding was performed sequentially using 400, 600, 800, and 1200 grit abrasives to achieve a flat and smooth surface. During the micro-Vickers hardness test, an indentation load of 0.3 kgf was applied, resulting in an indentation diagonal length in the range of 35 to 45 μm. Hardness measurements were repeated five times for each sample, and the average value was calculated. To ensure measurement reliability, each measurement was performed at a location spaced by a distance greater than three times the indentation diagonal length from the previous indentation site. The results are presented in FIG. 8.

Referring to FIG. 8, Example 1 exhibited a hardness value in the range of 500 to 600 MPa, whereas Comparative Example 2 showed a hardness value of approximately 300 MPa. That is, the Co-Ni alloy-plated interconnect was found to exhibit significantly higher hardness compared to the pure Co-plated interconnect.

Therefore, from the above results, it is concluded that the Co-Ni alloy thin films exhibit superior mechanical properties compared to the pure Co thin film. Furthermore, as the Co content in the Co-Ni alloy increases, the tensile strength, elongation, and hardness also increase simultaneously.

### ASR Evaluation of Co-Ni Alloy-Plated Interconnects

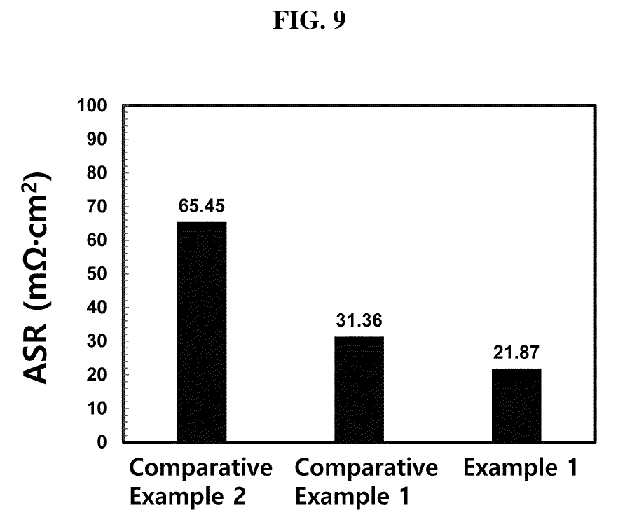

To evaluate the effectiveness of chromium volatilization suppression in the alloy thin films, an area-specific resistance (ASR) test was conducted after thermal oxidation at 800°C for 500 hours. ASR is a key parameter representing the electrical resistance per unit area in electrochemical systems. A lower ASR value indicates reduced energy loss and improved system efficiency in solid oxide fuel cells (SOFCs). Samples of Example 1, Comparative Example 1, and Comparative Example 2, each having a plating layer of a thickness of 1 μm on each side, were subjected to heat treatment at 800°C for 500 hours. Subsequently, the electrical resistance was measured at the same temperature using a four-probe method. The use of the four-probe technique allows separation of the current path and voltage measurement path, thereby enabling accurate measurement of the intrinsic resistance of the sample without contact resistance interference. The results are presented in FIG. 9.

Referring to FIG. 9, Comparative Example 2, in which the interconnect was plated with a pure Co thin film, exhibited an ASR value of 65.45 mΩ·cm², which is more than twice that of the interconnects plated with Co-Ni alloy thin films. Additionally, Comparative Example 1 and Example 1 showed ASR values of 31.36 mΩ·cm² and 21.87 mΩ·cm², respectively. These results demonstrate that the ASR decreases with increasing Co content in the Co-Ni alloy thin film.

A lower ASR of the interconnect provides several advantages in SOFC systems, including improved power output, extended lifetime, optimized operating temperature, and enhanced potential for miniaturization and weight reduction.

More specifically, since the interconnect electrically connects adjacent cells within an SOFC stack, a lower ASR facilitates more efficient current flow throughout the stack. This results in reduced voltage losses and enhanced power output. Additionally, higher electrical resistance typically leads to Joule heating, and thus, a lower ASR reduces heat generation, improving the reliability and durability of the entire stack. The efficient current flow due to low interconnect resistance enables stable operation of the SOFC even at relatively lower temperatures. This allows the use of less expensive materials in place of costly heat-resistant metals or ceramics, thereby reducing manufacturing costs. At the same time, reduced electrical losses make it possible to achieve the same power output with fewer cells, leading to a reduction in stack size, overall system weight, and associated installation and transportation costs.

In summary, by applying a Co-Ni alloy-plated interconnect, the ASR of the interconnect is significantly reduced, which in turn decreases current loss and heat generation. Consequently, the performance of the SOFC is enhanced, thereby achieving both stack miniaturization and cost reduction.

### Measurement of Chromium Volatilization and Microstructural Analysis of Co-Ni Alloy-Plated Interconnects

To quantitatively evaluate chromium volatilization from the Co-Ni alloy-plated interconnects, samples of Example 1 and Comparative Example 2 were prepared and subjected to heat treatment, followed by inductively coupled plasma–optical emission spectroscopy (ICP-OES) analysis.

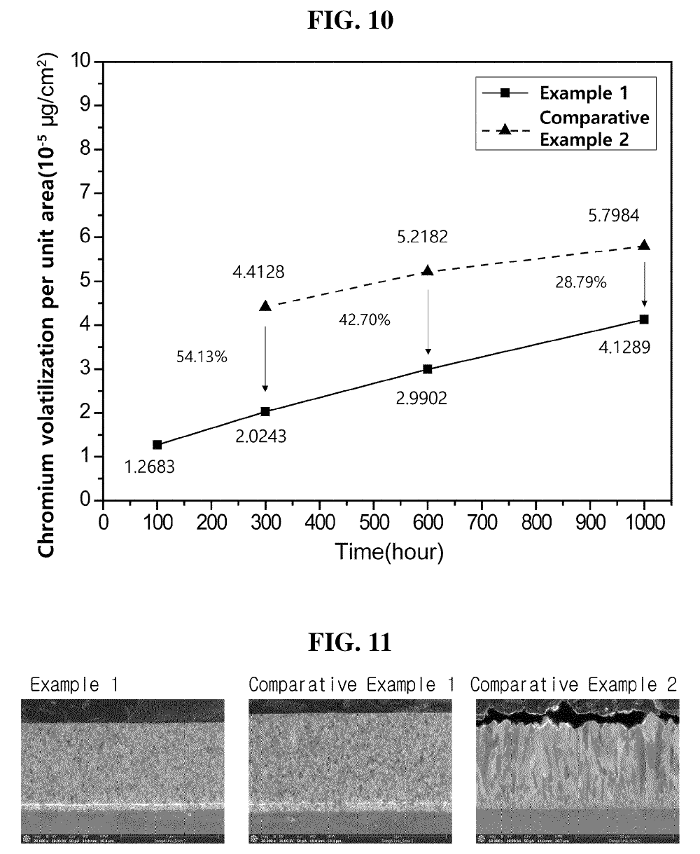

The samples were exposed to a temperature of 800°C under an atmosphere of air with 2% H₂O supplied at a flow rate of 5000 mL/min. The amount of volatilized chromium was measured after durations of 100, 300, 600, and 1000 hours. The results are presented in FIG. 10.

Referring to FIG. 10, compared to Comparative Example 2, the cumulative amount of volatilized chromium per unit area in Example 1 was reduced to approximately 28.79% to 54.13% of that of Comparative Example 2. Furthermore, when averaging the values obtained at 300, 600, and 1000 hours, chromium volatilization in Example 1 decreased by approximately 41.87% compared to Comparative Example 2.

These results provide strong evidence that the Co-Ni alloy coating effectively suppresses chromium volatilization, which is a critical degradation issue during SOFC operation. Consequently, improved long-term stability during prolonged operation is expected.

To further investigate the microstructural characteristics, focused ion beam (FIB) channeling images of Example 1, Comparative Example 1, and Comparative Example 2 were obtained and are shown in FIG. 11.

Referring to FIG. 11, Example 1 and Comparative Example 1, in which the interconnect was plated with Co-Ni alloy, exhibited an equiaxed grain structure at the nanometer scale.

On the contrary, Comparative Example 2, in which the interconnect was plated with a pure Co thin film, showed an elongated dendritic structure at the micrometer scale. These confirm that, in addition to solid solution strengthening arising from the substitutional alloying of Co and Ni, grain refinement also contributes to the enhancement of mechanical strength.

In conclusion, the application of a Co-Ni alloy coating to the interconnect of a solid oxide fuel cell is expected to provide an interconnect with superior mechanical properties and electrical conductivity, while effectively suppressing chromium volatilization.

The above-described embodiments are merely exemplary, and those skilled in the art will appreciate that various modifications and changes to the embodiments are possible.

Therefore, not only the embodiments but also their modifications and equivalents should be included within the true technical scope of the present disclosure as defined in the appended claims.

What is claimed is:

1. A solid oxide fuel cell including an alloy-plated interconnect, the solid oxide fuel cell comprising:
a plurality of unit cells, each having a fuel electrode, an air electrode, and a solid oxide electrolyte interposed therebetween;
an interconnect configured to electrically connect the plurality of unit cells to each other; and
a Co-Ni alloy thin film formed on a surface of the interconnect, the Co-Ni alloy thin film containing 50% to 84% Co, exhibiting a mixed phase of FCC and HCP structures, and having an equiaxed grain structure at the nanometer scale.

2. The solid oxide fuel cell of claim 1, further comprising:
a Co strike plating layer formed between the surface of the interconnect and the Co-Ni alloy thin film.

3. A method for manufacturing a solid oxide fuel cell including an alloy-plated interconnect, the method being for preparing the interconnect that is applicable to manufacture of a solid oxide fuel cell including a plurality of unit cells, each having a fuel electrode, an air electrode, and a solid oxide electrolyte disposed therebetween, and an interconnect electrically connecting the unit cells to each other, and the method comprising:
preparing an Fe-Cr-based interconnect;
plating a Co strike on the Fe-Cr-based interconnect; and
electroplating a Co-Ni alloy thin film on the strike-plated Fe-Cr-based interconnect.

4. The method of claim 3, wherein the electroplating of the Co-Ni alloy thin film is performed by immersing the strike-plated Fe-Cr-based interconnect in a Co-Ni alloy plating solution containing 40 to 70 g/L of CoCl₂·6H₂O, and
wherein the Co-Ni alloy thin film contains 50% to 84% Co.

5. The method of claim 3, wherein the Co-Ni alloy thin film exhibits a mixed phase of FCC and HCP structures.

6. The method of claim 3, wherein the Co-Ni alloy thin film has an equiaxed grain structure at the nanometer scale.
